(19) United States
(12) Patent Application Publication
(10) Pub. No.: US 2008/0241664 A1
(43) Pub. Date: Oct. 2, 2008

(54) Battery Electrodes and Batteries Including Such Electrodes

(76) Inventors: Kirakodu S. Nanjundaswamy, Sharon, MA (US); Jonathan M. Boulton, North Attleboro, MA (US); George M. Cintra, Holliston, MA (US); Alexander Kaplan, Providence, RI (US)

Correspondence Address: FISH & RICHARDSON P.C., P.O. BOX 1022, MINNEAPOLIS, MN, 55440-1022, US

(21) Appl. No.: 11/776,192

(22) Filed: Jul. 11, 2007

Related U.S. Application Data
(60) Provisional application No. 60/908,085, filed on Mar. 26, 2007.

(51) Int. Cl. H01M 2/00

(52) U.S. Cl. 429/128; 429/163

(57) ABSTRACT

A battery can include a housing, a cathode within the housing, and an anode within the housing. The cathode can include a lithium ion active cathode material and a network of conductive metallic material within the active cathode material. The cathode can have a thickness of at least 1 mm.

### RELATED APPLICATIONS

This application claims priority under 35 U.S.C. § 119(e) from U.S. Provisional Patent Application Ser. No. 60/908,085, filed Mar. 26, 2007, the entire contents of which are herein incorporated by reference.

### BACKGROUND

Generally, Li (lithium) batteries and Li-ion (lithium ion) batteries are fabricated using relatively thin electrodes that have been deposited on metallic foils or expanded metallic grids. These electrodes typically range in thickness from about 0.1 to 0.25 mm and are wound with a separator film into a cylindrical or prismatic assembly, commonly called a “jelly roll.”

The construction of this wound cell is more complex and costly than a comparable size alkaline cell fabricated using a bobbin construction. Cells including these thin electrodes also tend to have relatively low energy densities, due to the proportionally large inactive volume occupied by the current collectors, separator, and other inactive components. Nonetheless, thin electrodes in a jelly roll construction are used because of electronic and ionic conductivity limitations present in the electrodes and the electrolyte.

The electrode formulations used for deposition onto metallic foils or expanded metallic grids are typically based on a solvent phase, an active material, a conductive additive, and an organic polymeric binder. After evaporation of the solvent, the binder binds the particulate material and provides mechanical strength and adhesion. However, due to the insulating nature of the polymer only limited amounts can be used without impacting the electrochemical performance of the electrode, thus limiting the electrode strength that can be obtained. As a result, the thickness of the electrode is generally limited to less than about 0.25 mm to prevent cracking and/or delamination.

### SUMMARY

Conventional wound arrangements, such as “jelly-roll” arrangements, generally include a large volume of current collector and separator material, which occupies a significant volume of the cell. Reducing the amount of current collector and separator material used allows for the addition of additional active materials into a cell. By replacing the conventional arrangement with a bobbin cell construction, up to an extra 25 percent of active material can be used in an AA or AAA cell, leading to a significant energy density increase. Using the thicker electrode described herein allows for the construction of simple low cost bobbin lithium cells having an adequate rate capability under both charge and discharge conditions. It also allows for the construction of higher density cells of other types, such as a prismatic construction. The thicker electrodes described herein enable a range of new cell arrangements capitalizing on the high energy density of lithium systems.

In one aspect, a battery is disclosed that includes a housing, a cathode within the housing, and an anode within the housing. The cathode includes a lithium ion active cathode material and a network of conductive metallic material within the active cathode material. In some implementations, the cathode can have a thickness of at least 1 mm.

In some implementations, the network of conductive metallic material includes an open-cell metallic foam. The conductive metallic material can include aluminum.

In some implementations, the network of conductive metallic material includes a metallic filler. The metallic filler can include powder, flakes, fibrils, fibers, or a combination thereof The metallic filler can be pressed or sintered in place to form a continuous network throughout the active cathode material.

In some implementation, the network of conductive metallic material includes a metal alloy that expands or contracts upon charge or discharge.

In some implementations, the anode includes an active anode material and an anode network of conductive material within the active anode material. The active anode material can include mesocarbon microbeads (MCMB), Li₄Ti₅O₁₂, or a combination thereof The anode network of conductive material can include an open-cell metallic foam. The anode network of conductive material can include copper. In some implementations, the anode network of conductive material can include a metallic filler. The metallic filler can include powder, flakes, fibrils, fibers, or a combination thereof The metallic filler can be pressed or sintered in place to form a continuous network throughout the active anode material.

In some implementations, the battery also includes a separator between the cathode and the anode. The separator can include porous polyolefin. In some implementations, the separator can include ceramic or glass.

In some implementations, the network of conductive metallic material includes a surface layer of active-cathode-free pores. The surface layer of active-cathode-free pores can, in some implementations, be oxidized. In some implementations, the surface layer of active-cathode free pores can be sufficiently thick to serve as a separator between the cathode and the anode.

In some implementations, the active cathode material includes Li[Ni_{0.33}Co_{0.33}Mn_{0.33}]O₂, LiFePO₄, LiCoO₂, LiMn₂O₄ or a combination thereof. In some implementations, the cathode can have a thickness of between about 2 mm to about 10 mm. In some implementations, the cathode includes between about 5 and about 15 weight percent of the conductive material.

In some implementations, the battery can be a secondary battery.

In some implementations, the battery can be constructed as a stacked layer prismatic construction. In other implementations, the battery can have a bobbin cell construction. In some implementations, the battery includes a plurality of stacking disks each having at least one cathode region and at least one anode region.

In some implementations, the battery has a rate capacity of at least about 1.5 mA/cm².

In another aspect, a secondary battery includes a housing and at least one cell within the housing having a bobbin-type cell construction. The cell can include at least two electrodes including a cathode and an anode. Each electrode can include an active electrode material. The cathode can include a lithium ion active cathode material and the anode can include an active anode material. At least one of the electrodes can include a network of conductive material within the active electrode material. In some implementations, the cathode can include the network of conductive material and the network of conductive material can include an aluminum open-cell metallic foam. In some implementations, the anode can include the network of conductive material. In some implementations, the network of conductive material can include a copper open-cell metallic foam. In some implementations, the active cathode material includes Li[Ni_{0.33}Co_{0.33}Mn_{0.33}]O₂, LiFePO₄, LiCoO₂, LiMn₂O₄ or a combination thereof. In some implementations, the active anode material can include mesocarbon microbeads (MCMB), Li₄Ti₅O₁₂, or a combination thereof.

In some implementations, the secondary battery can include a separator between the cathode and the anode. In some implementations, the battery can include a plurality of stacking disks each comprising at least one cathode region and at least one anode region. In some implementations, the secondary battery can have a rate capacity of at least about 1.5 mA/cm2.

In another aspect, a primary battery includes a housing and at least one cell within the housing having a bobbin-type cell construction. The cell can include at least two electrodes including a cathode and an anode, each electrode can include an active electrode material. The cathode can include an active cathode material and the anode can include an active anode material. At least one of the electrodes can include a network of conductive material within the active electrode material. In some implementations, the cathode can include the network of conductive material. In some implementations, the anode can include the network of conductive material. In some implementations, the network of conductive material can include an aluminum open-cell metallic foam. In some implementations, the network of conductive material can include a copper open-cell metallic foam. In some implementations, the active cathode material can include MnO₂, FeS₂, NiS₂, MnS₂, CuS, CuO, V₂O₅, AgV₄O₁₁, or a combination thereof. In some implementations, the active anode material can include a metallic lithium foil, a metallic lithium powder, or a combination thereof.

In some implementations, the primary battery can include a separator between the cathode and the anode. In some implementations, the primary battery can include a plurality of stacking disks each including at least one cathode region and at least one anode region.

The details of one or more implementations are set forth in the accompanying drawings and the description below. Other features, objects, and advantages of the various implementations will be apparent from the description and drawings, and from the claims.

### DESCRIPTION OF DRAWINGS

FIG. 1A is a diagrammatic top view of a cylindrical stacking disc (or pellet) for a bobbin cell construction according to one implementation.

FIG. 1B is a diagrammatic top view of a cylindrical stacking disc (or pellet) for a bobbin cell construction schematically depicting a network of conductive metallic material within an active cathode material.

FIG. 1C is a diagrammatic perspective view showing a cylindrical stack of such cylindrical stacking discs.

FIGS. 2A-2G are diagrammatic top views of cylindrical stacking discs (or pellets) for bobbin cell constructions according to additional implementations.

FIG. 3 is a schematic perspective view of a stacked prismatic cell.

FIGS. 4A and 4B are graphical depictions of porosities of Al foam materials investigated when (a) rolled down from 3.2 mm and (b) rolled down from 6.4 mm.

FIG. 5 is a graphical depiction of performance of a bag cell using an Al foil based cathode.

FIG. 6 is a graphical depiction of performance of a bag cell using a 1 mm Al foil LFP based cathode.

FIGS. 7A and 7B are graphical depictions of discharge performances of a bag cell using a 2 mm Al foil LFP based cathode.

FIG. 8 is a graphical depiction of performance of a bag cell using a Cu foil MCMB based anode.

### DETAILED DESCRIPTION

Electrochemical cells can be a primary cells or a secondary cells. Primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995). Secondary electrochemical cells can be recharged for many times, e.g., more than fifty times, more than a hundred times, or more. In some cases, secondary cells can include relatively robust separators, such as those having many layers and/or that are relatively thick. Secondary cells can also be designed to accommodate for changes, such as swelling, that can occur in the cells. Secondary cells are described, e.g., in Falk & Salkind, “Alkaline Storage Batteries”, John Wiley & Sons, Inc. 1969; U.S. Pat. No. 345,124; and French Patent No. 164,681, all hereby incorporated by reference. Both primary and secondary cells can have bobbin cell arrangements or prismatic arrangements.

### Bobbin Cell Arrangements

Bobbin cell arrangements can include ring and rod shaped electrodes. For example, a bobbin cell arrangement can include a center ring or rod of cathode material and a surrounding ring of anode material. In other bobbin arrangements, additional rings or rods of anode or cathode material can also be present. Bobbin cell arrangements can also have a non-circular cross-sectional shape.

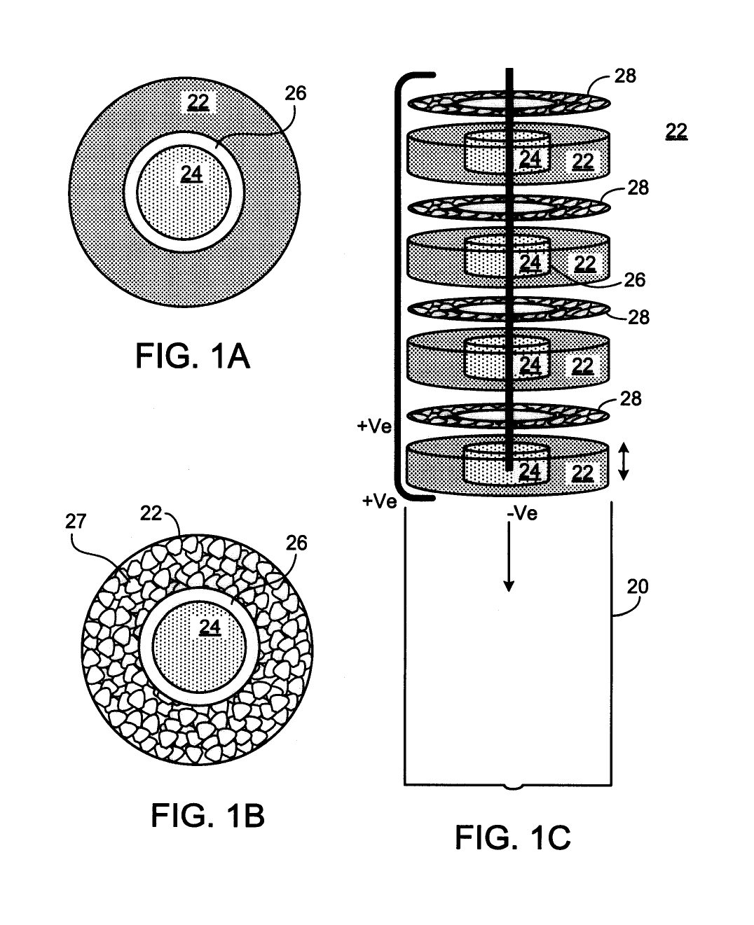

FIGS. 1A and 1B show two types of cylindrical stacking discs (or pellets) that may be used in bobbin cell constructions. Each stacking disc shown includes a cathode 22, an anode 24, and a separator 26 between the cathode 22 and the anode 24. As shown in FIG. 1B, the cathode 22 can include a network 27 of conductive metallic material within the active cathode material of the cathode 22. In some implementations (not shown), the anode 24 can also include a network of conductive material within the active anode material of the anode 24.

FIG. 1C depicts a perspective view showing a cylindrical stack of cylindrical stacking discs, such as those described above and shown in FIGS. 1A and 1B. A cylindrical stack of such cylindrical stacking discs can be used to construct a bobbin cell construction. In the implementation shown, grids 28 are positioned between adjacent cylindrical stacking discs. A grid 28 can collect current between adjacent cylindrical stacking discs. Any open metallic structure can function as a grid 28 e.g., a punched metal foil, a woven or welded wire mesh or an expanded (slit and stretched) metal. Expanded metal grids are commercially available for this purpose e.g., from Dexmet Corporation, Naugatuck, Conn. Typically they range in thickness from 1 to 5 mils. Placing such a grid between the stacking electrode discs provides a highly conductive pathway to the external battery housing thus providing lower internal resistance. In other implementations, not shown, the cylindrical stacking discs can be positioned without intermediate grids 28. The cylindrical stack may be positioned within a battery housing 20. In some implementations, the battery can include a current collector 32. A current collector 32 can collect current from an anode 24, for example as shown, or from a cathode 22, depending upon the arrangement of the cathode and anode materials within the cell.

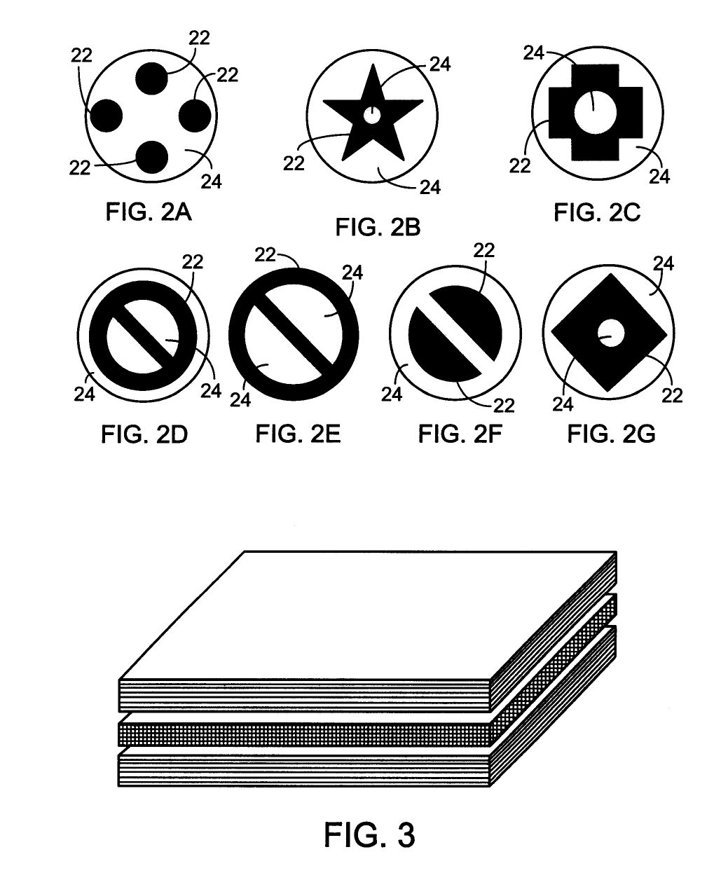

FIGS. 2A-2B depict various other cylindrical stacking disc implementations. Each of these various cylindrical stacking disc implementations can be used to create bobbin cell arrangements. An arrangement can be selected to result in the desired amount of common surface area between anodes 24 and cathodes 22. The number of electrodes used in a cell can also vary depending on the required cell performance.

Although the bobbin cell arrangement is shown as a stacked disc bobbin cell arrangement, other bobbin cell arrangements are possible. For example, a battery can include separately formed anode 24 and cathode 22 sections separately placed within a battery housing.

### Prismatic Arrangement

FIG. 3 depicts a stacked layer prismatic construction. A stacked layer prismatic construction includes layers of cathode 22 and layers of anode 24. Each layer of cathode 22 or anode 24 can be at least 1 mm thick. In some implementations, each layer of cathode 22 and/or anode 24 can be at least 1.5 mm thick (e.g., between 2 mm and 10 mm thick). In some implementations, as shown, a prismatic construction includes a layer of separator 26 between alternating layers of cathode and anode material.

In the case of a conventional lithium ion prismatic battery, such as the NP-60 design, the flat spirally wound electrode stack assembly can be replaced by a simple stacked electrode assembly as shown in FIG. 3. The stacked electrodes 22, 24 can include active electrode material pressed in the form of pellets or impregnated into preformed networks 27 of conductive metallic material, or produced by molding/pressing active materials with metallic powders to form in-situ conductive metallic networks 27.

### Electrode Structure

The cathode 22 can include a lithium ion active cathode material. For example, the cathode can include Li[Ni_{0.33}Co_{0.33}Mn_{0.33}]O₂, LiFePO₄, LiCoO₂, LiMn₂O₄ or a combination thereof as the active cathode material. In some implementations, the cathode can have a thickness of at least 1 mm (for example, at least 1.5 mm thick, or between 2 mm and 10 mm thick). In some implementations, the network of conductive material can include aluminum. In some implementations, the cathode 22 can be part of a secondary cell.

As noted above, the anode 24 can include an active anode material (for example, mesocarbon microbeads or Li₄Ti₅O₁₂) and an anode network of conductive material within the active anode material. The anode active material can also include graphite, amorphous carbon, alloy anodes, metal compounds (oxides, chalcogenides and other compounds), or combinations thereof. In some implementations, the anode network of conductive material can include copper. In some implementations, the anode 24 can be part of a secondary cell.

The network of conductive metallic material can serve as a current collector embedded in the electrode (the cathode 22 and/or the anode 24) and thus provide good electrical conductivity. The composite of the active material (anode and/or cathode) and the network of conductive material can be fabricated using a variety of methods, including depositing active electrode material into a preformed network 27 (e.g., a metallic foam) by using various coating and/or infiltration procedures. For example, a curtain-coating procedure could be used to form the composite.

In some implementations, the network of conductive material can include an open-cell metallic foam. An open-cell metallic foam can be machined or formed into a shape, before or after deposition of active electrode material, to produce, for example, ring-shaped electrodes for battery designs such as bobbin cells. The foam can be treated prior to the deposition of the active electrode material, e.g., to remove oxide and/or coated with a primer material to improve conductivity and adhesion.

A variety of slurry formulations with different binders and/or solvents can be used to infiltrate a foam or other network of conductive metallic material with the active electrode material. In some implementation, an aqueous based binder may be used (e.g., latex binders & rheology modifiers) for coating the active material on the foam.

A foam matrix may allow for better thermal dissipation than a conventional “jelly roll” arrangement, e.g., in cells that charge or discharge at rates that result in heat generation. The electrode (cathode or anode) can include two or more foams having different metal contents (i.e., different relative densities) or different pore sizes sandwiched together (before of after infiltration or coating of active materials).

Alternatively, the network of conductive metallic material can include a metallic filler. The metallic filler can include powder, flakes, fibrils, fibers, or a combination thereof. The metallic filler can be pressed or sintered in place to form a continuous network throughout the active material.

In some implementations, the network of conductive material can include a metal alloy that expands or contracts on charge or discharge. In some implementations, the active cathode material and/or the active anode material can expand or contract on charge or discharge. By matching the expansion characteristics, the combination of the active electrode materials and the network materials can be selected to prevent separation or delamination of the electrodes in a battery during use.

Two different types of active material may in some cases be coated on opposite sides of a network 27 for specific applications, for example for the controlled discharge/charge of the active materials in a desired order. For example, the side of the cathode 22 that faces the anode 24 directly can have a coating of an active cathode material that helps to control the overcharge better, such as LiFePO₄, and the other side of the network 27 can be coated with a high capacity material that has low tolerance to overcharge, such as LiCoO₂.

In some implementations, the electrode can be highly porous. For example, the use of a foam network 27 of conductive material can allow for high levels of porosity within the active electrode material (cathode 22 or anode 24) and result in higher discharge/charge efficiency of the active metals. For example, pore-forming additives could be incorporated into the coating and/or infiltration slurry to aid in the development of the required porous structure within the active electrode material. Pore formers can include any material that can be subsequently removed from the prepared electrode to leave a void. Such material can be removed by a number of methods including heating (this can be done under vacuum) and washing with a solvent in which the electrode components are insoluble but which the pore formers are soluble. Example materials which can be used as pore formers include sulfolane and ethylene carbonate. Various Li salts can also be used as pore formers—they can be soluble and compatible with the electrolyte. Introducing porosity is beneficial in the electrode to improve the electrode kinetics and thus the rate capability of the cell.

In some implementations, the battery can be a primary lithium battery using metallic Li foil or powder as the anode. In such a primary lithium battery the active cathode material can include materials such as MnO₂, FeS₂, NiS₂, MnS₂, CuS, CuO, V₂O₅, and/or AgV₄O₁₁. In some implementations, these primary lithium batteries fabricated with a bobbin cell construction can be connected in series to provide a voltage comparable to a conventional lithium ion cell e.g., two NiS₂ cells can be connected in series to provide a 3.6V battery.

### Separator

In some implementations, a battery can include a separator 26 between the cathode 22 and the anode 24. A separator 26 can be positioned within cylindrical stacking discs, as shown in FIGS. 1A and 1B, can be positioned between independent anodes and cathodes in another bobbin cell arrangement (not shown), or can be positioned between layers of cathode and anode material in a prismatic construction, as shown in FIG. 3.

In some implementations, the separator can include porous polyolefin. In some implementations, the separator can include ceramic or glass. In some implementations, an insulating porous coating can be deposited on the electrodes to function as the separator.

In some implementations, the network of conductive metallic material can include a surface having active-material-free pores. For example, this can be achieved by the selective coating and/or infiltration of a preformed network 27, such as a metallic foam. The surface having active-material-free pores can be oxidized, and can be sufficiently thick to serve as a separator between the cathode 22 and the anode 24. This procedure can be used to create a separator between anodes and cathodes by creating the separator on a surface of either the anode or the cathode.

### Electrolyte

In some implementations, a battery can include an electrolyte. In Li-ion technology, the electrolyte is not consumed during charge and discharge. The electrolyte amount in the cell can be based upon the porous volume available within the cell.

### EXAMPLE 1

### Fabrication of Network for Use in a Thick Electrodes

Open cell aluminum foam was purchased from Goodfellow Corporation (Devon, Pa.). The foam includes aluminum 6101 and had the following properties:
Thickness: 3.2 mm and 6.4 mm
Bulk density: 0.2 g/cm³
Pores/cm: 16
Porosity: 93%

For reference, the typical composition of aluminum 6101 is as follows:

| Al | Balance |
|---|---|
| B | 0.06 max |
| Cr | 0.03 max |
| Cu | 0.1 max |
| Fe | 0.5 max |
| Mg | 0.35-0.7 |
| Mn | 0.03 max |
| Si | 0.3-0.7 |
| Zn | 0.1 |

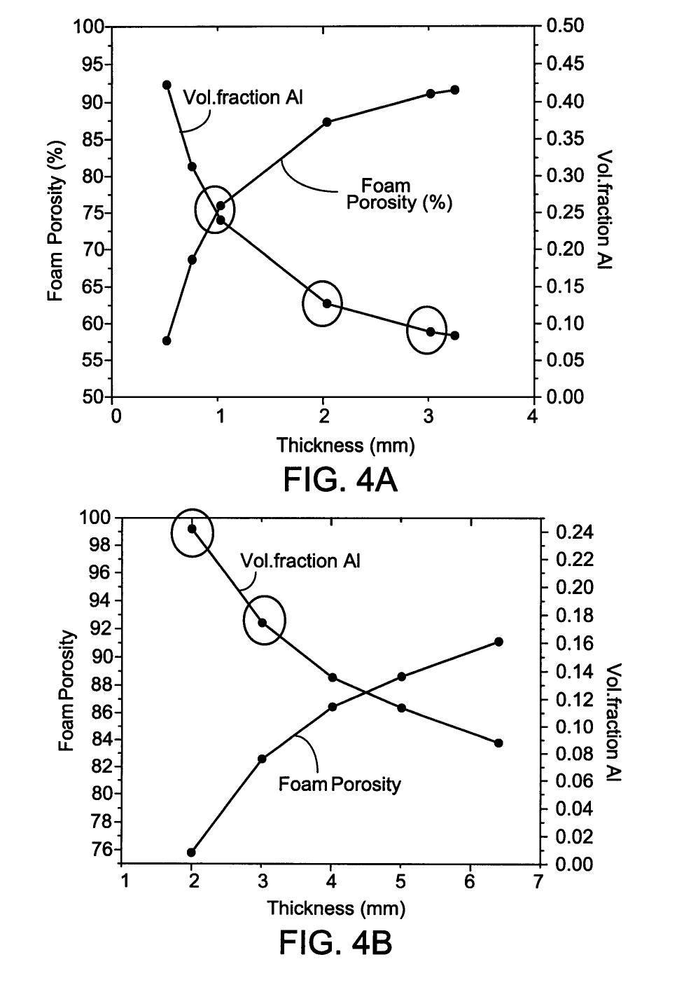

Aluminum 6101 is a high electrical conductivity aluminum alloy that also possesses good mechanical (strength) properties. The electrical conductivity is 56% that of copper and the density of the alloy is 2.685 g/cm³. Prior to electrode fabrication the as-received 3.2 and 6.4 mm foams were successively rolled with a jeweler's mill to prepare thinner foams. The effect of thickness reduction on the porosity of the materials is shown in FIGS. 4A and 4B. FIG. 4A shows the effect on porosity for a foam rolled down from 3.2 mm. FIG. 4B shows the effect on porosity for a foam rolled down from 6.4 mm.

### EXAMPLE 2

### Fabrication of a 1 mm Li[Ni_{0.33}Co_{0.33}Mn_{0.33}]O₂ Cathode

The original 3.2 mm foam was cut into 5 cm wide strips and successively rolled down with a jeweler's mill to yield a material of about 1 mm in thickness. The 1 mm foam was cut into a rectangular block of 7 cm×13.5 cm. One of the long sides was masked with tape on the edge (2 mm). The foam was placed on a silicone-coated release liner and a N-methylpyrrolidinone cathode slurry was poured and spread on the foam. This process was repeated two times to completely infiltrate the foam. The composition of the cathode slurry was (in wt. %):
88% Li[Ni_{0.33}Co_{0.33}Mn_{0.33}]O₂
2% KS-6 graphite
4% SAB carbon black
6% Atofina 761A PVDF

After infiltration, the foam was dried at 80° C. and passed through a 1 mm gap setting on a jeweler's mill. The material was further dried at 80° C. under vacuum and cut to give a 4.7 cm×3.5 cm electrode with a 0.2 cm uncoated region at the top of the electrode (active area=15.75 cm² and total area=16.45 cm²) with an electrode loading of 135 mg /cm². This equates to 1350 mg/cm³. This loading is similar to a conventional electrode coated onto aluminum foil. At 135 mAh/g, this electrode has a theoretical capacity of about 253 mAh. In 1 cm³ of such an electrode the foam Al current collector would constitute 24% of the total volume.

For comparison, the same slurry was coated on both sides of 0.7 mil Al foil to a loading of 22.2 mg/cm². After being calendered to a total thickness of 6.5 mil the electrode loading was 1345 mg/cm³. In 1 cm³ of such an electrode the foil Al current collector would constitute ˜10.8% of the total volume.

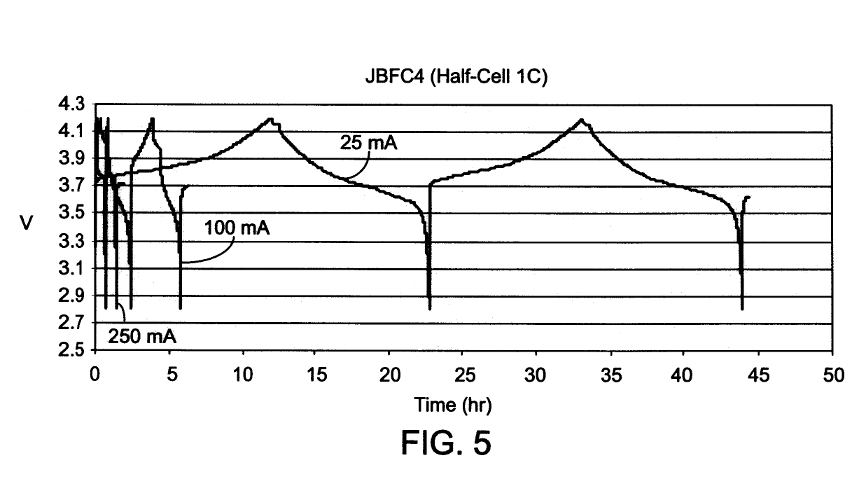

A nickel tab was spot-welded to the masked region of the foam and a bag cell was fabricated using a Celgard™ 2325 separator, 1M LiPF₆ in EC/DMC electrolyte and 3.5 mil lithium foil. The cell was cycled between 4.2V and 2.8V at increasing rates: 25, 100, 250 mA. The performance of the bag cell is shown in FIG. 5.

The data is also tabulated in Table I below:

TABLE I

| Rate | mA/cm² | mAh (1^{st} cycle) | mAh (2^{nd} cycle) |
|---|---|---|---|
| 25 mA | 1.6 | 258 | 256 |
| 100 mA | 6.3 | 154 | 140 |
| 250 mA | 15.9 | 28 | 28 |

These results show that an acceptable rate capability can be obtained from the 1 mm cathode using an aluminum foam support/current collector. For example, full theoretical capacity can be obtained at a rate of 1.6 mA/cm². In comparison, the rate capability of a commercial high energy Li-ion rechargeable battery (1.8 Ah 18650 cell) utilizing much thinner electrodes (about 0.18 mm with˜503 cm² of cathode surface area) is ˜1.8 mA/cm² at a C/2 rate.

### EXAMPLE 3

### Fabrication of a 1 mm LiFePO₄ Cathode

As described in Example 1, 1 mm foam was prepared from the original 3.2 mm foam, was cut into 5 cm wide strips, and successively rolled down with a jeweler's mill to yield a material 1 mm in thickness. The foam (5 cm×2 cm with a 1 cm×2 cm) masked region was dipped into the N-methylpyrrolidinone cathode slurry and excess material was removed. This process was repeated two times to completely infiltrate the foam.

The composition of the cathode slurry was (wt. %):
86% in-situ carbon coated LiFePO₄
2.7% KS-6 graphite
5.3% SAB carbon black
6% Atofina 761 A PVDF

Using such a formulation and the aluminum foam substrate, electrodes could be readily prepared. In contrast, attempts to coat this formulation on conventional aluminum foil to any reasonable loading level resulted in severe cracking and loss of adhesion of the electrode.

After infiltration, the foam was dried at 80° C. and again passed through a 1 mm gap setting on a jeweler's mill. The material was further dried at 80° C. under vacuum and trimmed to give an electrode with an active area of 4 cm×2 cm and an electrode loading of 106 mg /cm².

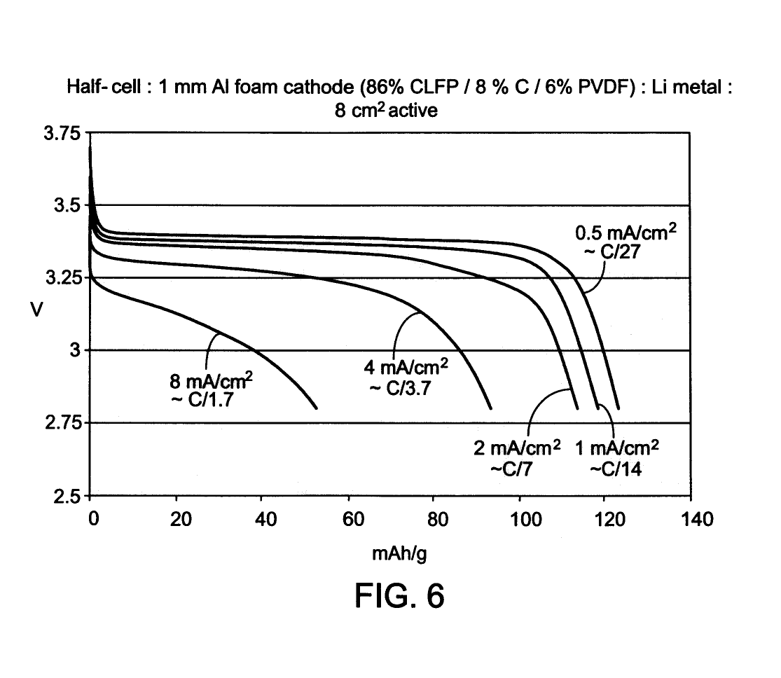

A nickel tab was spot-welded to the masked region of the foam and a bag cell was fabricated using Celgard™ 2325 separator, 1M LiPF₆ in EC/DMC electrolyte and 3.5 mil lithium foil. The cell was cycled between 4.2V and 2.8V at increasing rates. The performance of the bag cell is shown below in FIG. 6 in terms of mAh/g of active LiFePO₄. Good rate performance was seen at 2 mA/cm².

### EXAMPLE 4

### Fabrication of a 2 mm LiFePO₄ Cathode

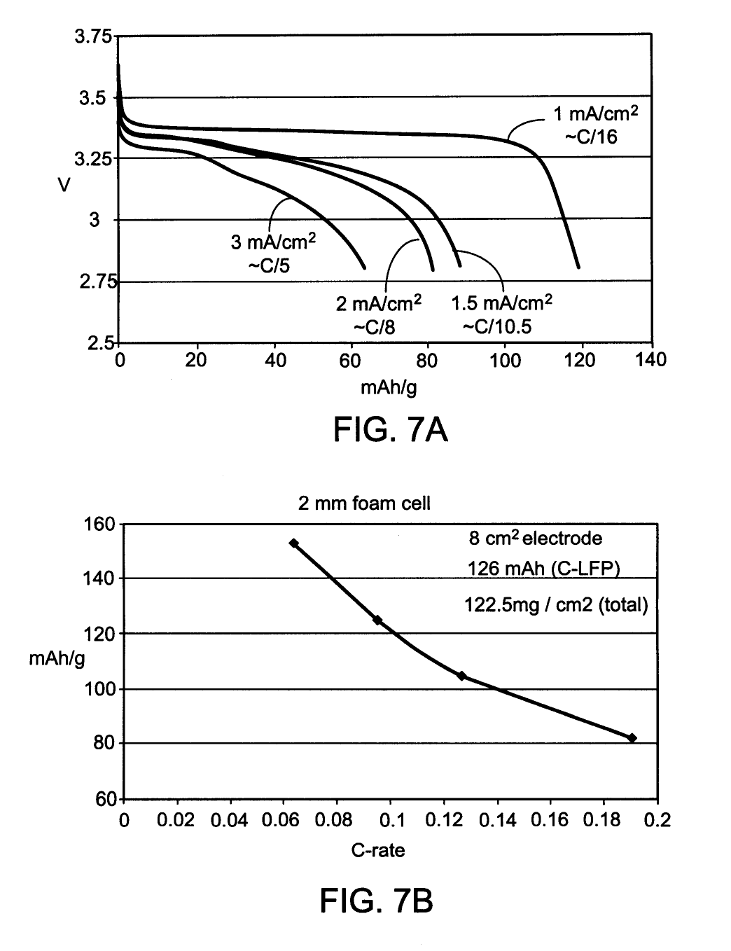

In a similar manner to that described in Example 2, a 2 mm LiFePO₄, cathode was prepared using 2 mm Al foam which was rolled down from the original 6.4 mm aluminum foam. The performance of the electrode in a bag cell is shown below in FIG. 7. As shown in FIG. 7 approximately 80% of the theoretical capacity of the electrode can be delivered at ˜C/10 rate from the 2 mm electrode, indicating that adequate performance can be obtained from such a thick cathode.

### EXAMPLE 5

### Fabrication of a Thick Mesocarbon Microbeads (MCMB) Anode

In a similar manner to that described in Examples 1-4, thick carbon-based anodes can be prepared using copper foam substrates. Open cell copper foam was obtained from EFoam (Circuit Foil Luxembourg Trading). The foam had the following properties:
Thickness: 2.0 mm
Bulk density: 0.2 g/cm³
Pores/cm: 18
Porosity: 98%

The original 2 mm foam was cut into 5 cm wide strips and successively rolled down with a jeweler's mill to yield a material 1 mm in thickness. Measurement of the apparent density indicated that the 1 mm foam had a porosity of 95%. The 1 mm foam was cut into a rectangular block of 7 cm×13.5 cm. One of the long sides was masked with tape on the edge (5 mm). The foam was placed on a silicone-coated release liner and a N-methylpyrrolidinone anode slurry was poured and spread on the foam. This process was repeated two times to completely infiltrate the foam. The composition of the anode slurry was (wt. %):
88% MCMB 28-10
6% SAB carbon black
6% Atofina 761A PVDF

The slurry also contained a small amount of oxalic acid: 3×10⁻³ g of oxalic acid/g of MCMB.

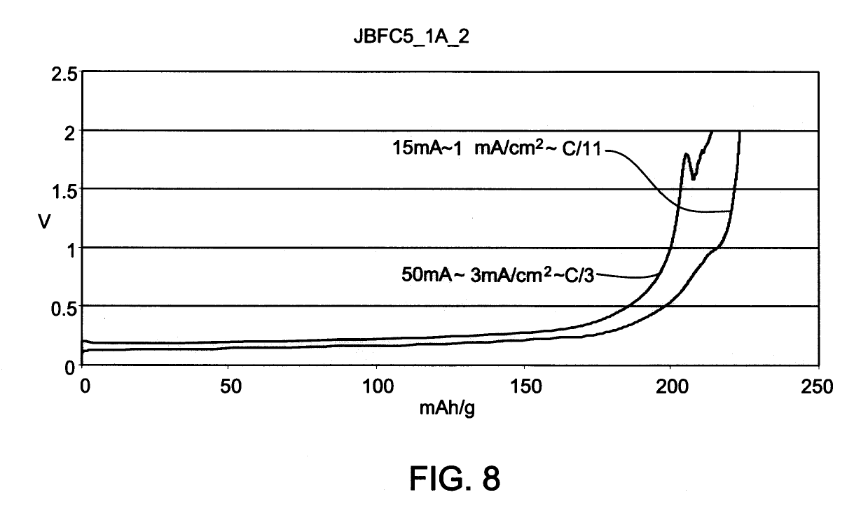

After infiltration the foam was dried at 80° C. and passed through a 1 mm gap setting on a jeweler's mill. The material was dried at 80° C. under vacuum and cut to give a 5 cm×3.5 cm electrode with a 0.5 cm uncoated region at the top of the electrode (active area=15.75 cm² and total area=17.5 cm²) with an electrode loading of 43 mg/cm². At 300 mAh/g, this electrode has a theoretical capacity of ˜179 mAh. A nickel tab was spot-welded to the masked region of the foam and a bag cell was fabricated using Celgard™ 2325 separator, 1M LiPF₆ in EC/DMC electrolyte, and 3.5 mil lithium foil. The Cu-foam based MCMB anode performed well in the foil bag test and the results shown in FIG. 8 indicate acceptable rate capability and performance from the thick, foam-based anode.

A number of implementations have been described. Nevertheless, it will be understood that various modifications may be made without departing from the spirit and scope of the claims.

What is claimed is:

1. A battery comprising:
a housing;
a cathode within the housing, the cathode comprising a lithium ion active cathode material and a network of conductive metallic material within the active cathode material, with the cathode having a thickness of at least 1 mm; and
an anode within the housing.

2. The battery of claim 1, wherein the network of conductive metallic material comprises an open-cell metallic foam.

3. The battery of claim 1, wherein the conductive metallic material comprises aluminum.

4. The battery of claim 1, wherein the network of conductive metallic material comprises a metallic filler.

5. The battery of claim 4, wherein the metallic filler comprises powder, flakes, fibrils, fibers, or a combination thereof.

6. The battery of claim 4, wherein the metallic filler is pressed or sintered in place to form a continuous network throughout the active cathode material.

7. The battery of claim 1, wherein the network of conductive metallic material comprises a metal alloy that expands or contracts upon charge or discharge.

8. The battery of claim 1, wherein the anode comprises an active anode material and an anode network of conductive material within the active anode material.

9. The battery of claim 8, wherein the active anode material comprises mesocarbon microbeads, Li₄Ti₅O₁₂, or a combination thereof.

10. The battery of claim 8, wherein the anode network of conductive material comprises an open-cell metallic foam.

11. The battery of claim 8, wherein the anode network of conductive material comprises copper.

12. The battery of claim 8, wherein the anode network of conductive material comprises a metallic filler.

13. The battery of claim 12, wherein the metallic filler comprises powder, flakes, fibrils, fibers, or a combination thereof.

14. The battery of claim 12, wherein the metallic filler is pressed or sintered in place to form a continuous network throughout the active anode material.

15. The battery of claim 1, further comprising a separator between the cathode and the anode.

16. The battery of claim 15, wherein the separator comprises porous polyolefin.

17. The battery of claim 15, wherein the separator comprises ceramic or glass.

18. The battery of claim 1, wherein the network of conductive metallic material comprises a surface layer of active-cathode-free pores.

19. The battery of claim 18, wherein the surface layer of active-cathode free pores is oxidized.

20. The battery of claim 18, wherein the surface layer of active-cathode free pores is sufficiently thick to serve as a separator between the cathode and the anode.

21. The battery of claim 1, wherein the battery comprises a bobbin-type construction.

22. The battery of claim 1, wherein the active cathode material comprises Li[Ni_{0.33}Co_{0.33}Mn_{0.33}]O₂, LiCoO₂, LiFePO₄, LiMn₂O₄ or a combination thereof.

23. The battery of claim 1, wherein the battery is a secondary battery.

24. The battery of claim 1, wherein the battery comprises a stacked layer prismatic construction.

25. The battery of claim 1, wherein the battery comprises a plurality of stacking disks each comprising at least one cathode region and at least one anode region.

26. The battery of claim 1, wherein the cathode comprises between about 5 and about 15 weight percent of the conductive material.

27. The battery of claim 1, wherein the battery has a rate capacity of at least about 1.5 mA/cm².

28. The battery of claim 1, wherein the cathode has a thickness of between about 2 mm to about 10 mm.

29. A secondary battery comprising:
a housing and
at least one cell within the housing having a bobbin-type cell construction, the cell comprising:
at least two electrodes including a cathode and an anode, each electrode comprising an active electrode material, the cathode comprising a lithium ion active cathode material, the anode comprising an active anode material, at least one of the electrodes comprising a network of conductive material within the active electrode material.

30. The battery of claim 29, wherein the cathode comprises the network of conductive material and wherein the network of conductive material comprises an aluminum open-cell metallic foam.

31. The battery of claim 29, wherein the anode comprises the network of conductive material.

32. The battery of claim 31, wherein the network of conductive material comprises a copper open-cell metallic foam.

33. The battery of claim 29, wherein the active anode material comprises mesocarbon microbeads (MCMB), Li₄Ti₅O₁₂, or a combination thereof.

34. The battery of claim 29, further comprising a separator between the cathode and the anode.

35. The battery of claim 29, wherein the active cathode material Li[Ni_{0.33}Co_{0.33}Mn_{0.33}]O₂, LiCoO₂, LiFePO₄, LiMn₂O₄ or a combination thereof.

36. The battery of claim 29, wherein the battery comprises a plurality of stacking disks each comprising at least one cathode region and at least one anode region.

37. The battery of claim 29, wherein the secondary battery has a rate capacity of at least about 1.5 mA/cm2.

38. A primary battery comprising:
a housing and
at least one cell within the housing having a bobbin-type cell construction, the cell comprising:
at least two electrodes including a cathode and an anode, each electrode comprising an active electrode material, the cathode comprising an active cathode material, the anode comprising an active anode material, at least one of the electrodes comprising a network of conductive material within the active electrode material.

39. The battery of claim 38, wherein the cathode comprises the network of conductive material.

40. The battery of claim 38, wherein the anode comprises the network of conductive material.

41. The battery of claim 38, wherein the network of conductive material comprises an aluminum open-cell metallic foam.

42. The battery of claim 38, wherein the network of conductive material comprises a copper open-cell metallic foam.

43. The battery of claim 38, further comprising a separator between the cathode and the anode.

44. The battery of claim 38, wherein the active cathode material comprises MnO₂, FeS₂, NiS₂, MnS₂, CuS, CuO, V₂O₅, AgV₄O₁₁, or a combination thereof.

45. The battery of claim 38, wherein the active anode material comprises a metallic lithium foil, a metallic lithium powder, or a combination thereof.

46. The battery of claim 38, wherein the battery comprises a plurality of stacking disks each comprising at least one cathode region and at least one anode region.
